(19) United States
(12) Patent Application Publication
(10) Pub. No.: US 2025/0214817 A1
(43) Pub. Date: Jul. 3, 2025

(54) ROBOTIC VEHICLE NAVIGATION WITH DYNAMIC PATH ADJUSTING

(71) Applicant: Seegrid Corporation, Pittsburgh, PA (US)

(72) Inventors: Nicholas Melchior, Pittsburgh, PA (US); Iva Jestrovic, Pittsburgh, PA (US); Tom Panzarella, Haddonfield, NJ (US); John Spletzer, Nokomis, FL (US); William Robert Ganucheau, JR., Lafayette, LA (US); Erich L. Foster, Pittsburgh, PA (US)

(21) Appl. No.: 18/849,629

(22) PCT Filed: Mar. 28, 2023
(86) PCT No.: PCT/US2023/016591

§ 371 Date: Sep. 23, 2024

Related U.S. Application Data
(60) Provisional application No. 63/324,195, filed on Mar. 28, 2022.

(51) Int. Cl. B66F 9/06; B66F 9/075; G01S 17/931

(52) U.S. Cl. CPC B66F 9/063; B66F 9/0755; G01S 17/931

(57) ABSTRACT

In accordance with one aspect of the inventive concepts, provided is a robotic vehicle comprising at least one processor in communication with at least one computer memory device, a navigation system operatively controlling a drive system to navigate the mobile robot along a predetermined path, at least one sensor configured to acquire real-time sensor data, and a dynamic path adjust system comprising computer program code executable by the at least one processor to cause the navigation system to at least partially and/or temporarily deviate from a current path by generating a dynamically determined path or path segment based on the real-time sensor data and/or an indication in the current path to switch to dynamic path adjust. The robotic vehicle can be configured to switch path to a current and/or original path after executing a dynamically determined path adjustment. A corresponding method is also provided.

### CROSS REFERENCE TO RELATED APPLICATIONS

The present application claims priority to U.S. Provisional Appl. 63/324,195 filed on Mar. 28, 2022, entitled NAVIGATION THROUGH FUSION OF MULTIPLE LOCALIZATION MECHANISMS AND FLUID TRANSITION BETWEEN MULTIPLE NAVIGATION METHODS, which is incorporated herein by reference in its entirety.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-Aware Localization System For Ground Vehicles; U.S. Provisional Appl. 63/324,184 filed on Mar. 28, 2022, entitled Safety Field Switching Based On End Effector Conditions; U.S. Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment, U.S. Provisional Appl. 63/324,192 filed on Mar. 28, 2022, entitled Automated Identification Of Potential Obstructions In A Targeted Drop Zone; U.S. Provisional Appl. 63/324,193 filed on Mar. 28, 2022, entitled Localization Of Horizontal Infrastructure Using Point Clouds; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object, and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design Patent Appl. 29/398,127, filed on Jul. 26, 2011, U.S. Pat. No. D680,142, Issued on Apr. 16, 2013, entitled Multi-Camera Head; U.S. Design Patent Appl. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. Patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of systems and methods in the field of robotic vehicles, such as autonomous mobile robots (AMRs). Aspects of the inventive concepts are applicable to any robotic vehicle application. More generally, it is applicable to any robotic vehicle with multiple navigation strategies that may be selected at runtime.

### BACKGROUND

Autonomous mobile robots (AMRs) have become increasingly used in a variety of environments. In many environments, AMRs can be used as an approach to automating or semi-automating previously human-only tasks. In environments where goods are stored, transported, and/or otherwise moved from place to place, AMRs can be used to automate or semi-automate the movement of such goods about and/or in and out of the environment.

To navigate from place to place, the AMR needs knowledge of its environment, its location within the environment, the location or locations of goods within the environment, and locations of any other objects or entities with which it will interact in performing its tasks. An AMR's knowledge of the environment can include an electronic map of the environment, which can be stored locally, onboard the AMR, remotely with real-time access by the AMR, or some combination thereof. Often times the AMR is taken on an initial training run through the environment during which the AMR uses onboard sensors to learn pathways and objects within the environment. In such a case, the AMR can build a map of the environment. The AMR can also be configured to use its sensors to collect environmental data during its task performance and update its locally stored electronic map based on the data it collects.

Training in this way by demonstration is an effective way for non-experts to teach robots to perform tasks, such as navigation, in a predictable manner. Interaction with the environment (e.g., manipulation or obstacle avoidance) requires precise planning and execution based on execution-time sensor feedback. Many tasks require a combination of these approaches, relying on dynamic combinations of sensing and actuation strategies at different stages. A mobile robot should select and execute these strategies during operation to perform its task.

To elaborate, navigation often depends on constraints that are difficult for a user (or even a programmer) to express: the geometric shape of the path, areas where precision is particularly important, locations where behaviors such as intersection management should be performed, etc. However, it is easy for a user to demonstrate the desired behavior. This is the strength of a current approach to path training.

On the other hand, tasks like manipulation require variations in behavior precisely parameterized by information about the world that can be sensed in real-time by the mobile robot. The dependence between sensing and action cannot be easily described in an algorithm written by the programmer. In addition, the method by which the robot localizes itself is dependent on the method of navigation. While following trained paths, a pre-built map will be available. When navigating more dynamically, based on sensor information, a local map can also be updated dynamically.

In some existing systems, software only supports navigation along trained paths with pre-built maps. Manipulation (e.g., picks and drops by a warehouse AMR) occur precisely at trained locations, with little variation is allowed based on sensor inputs.

### SUMMARY OF THE INVENTION

In accordance with aspects of the inventive concepts, provided is a robotic vehicle, comprising: at least one processor in communication with at least one computer memory device, a navigation system in operative control of a drive system to navigate the robotic vehicle along a predetermined path, at least one sensor configured to acquire real-time sensor data, and a dynamic path adjust module comprising computer program code executable by the at least one processor to cause the navigation system to generate at least one dynamically determined path or path segment based on the real-time sensor data. The at least one dynamically determined path or path segment at least partially and/or temporarily deviates from the predetermined path.

In various embodiments, the dynamic path adjust module is configured to cause the navigation system to resume navigation on the predetermined path after navigating the at least one dynamically determined path or path segment.

In various embodiments, the predetermined path is a trained path stored in the at least one computer memory device.

In various embodiments, the at least one sensor includes one or more three-dimensional sensors.

In various embodiments, the one or more stereo sensors includes one or more stereo cameras.

In various embodiments, the sensor data includes real-time pose data.

In various embodiments, the dynamic path adjust module is configured to determine a vehicle pose from the real-time pose data when transitioning from the predetermined path to the at least one dynamically determined path or path segment and to return the vehicle to the vehicle pose and transition back to the predetermined path.

In various embodiments, the path adjust module is configured to swap a path segment from the predetermined path with a dynamically created path segment.

In various embodiments, the path adjust module is configured to replace a remainder of the predetermined path with the one or more dynamically determined path or path segments.

In various embodiments, the robotic vehicle is an autonomous mobile robot lift truck or tugger.

In accordance with another aspect of the inventive concepts, provided is a path adjust method for a robotic vehicle. According to the method, the robotic vehicle comprises at least one processor in communication with at least one computer memory device; a navigation system operatively controlling a drive system to navigate the robotic vehicle along a predetermined path; at least one sensor; and a dynamic path adjust module comprising computer program code executable by the at least one processor. The method includes navigating the robotic vehicle on a predetermined path; collecting sensor data in real-time; and executing the dynamic path adjust module program code, including generating at least one dynamically determined path or path segment based on the real-time sensor data, wherein the at least one dynamically determined path or path segment at least partially and/or temporarily deviates from the predetermined path.

In various embodiments, the method includes the dynamic path adjust module causing the navigation system to resume navigation on the predetermined path after navigating the at least one dynamically determined path or path segment.

In various embodiments, the predetermined path is a trained path stored in the at least one computer memory device.

In various embodiments, the at least one sensor includes one or more three-dimensional sensors.

In various embodiments, the one or more stereo sensors includes one or more stereo cameras.

In various embodiments, the method further comprises determining real-time pose data from the sensor data.

In various embodiments, the method further comprises the dynamic path adjust module determining a vehicle pose from the real-time pose data when transitioning from the predetermined path to the at least one dynamically determined path or path segment and returning the vehicle to the vehicle pose and transitioning back to the predetermined path.

In various embodiments, the method further comprises the path adjust module swapping a path segment from the predetermined path with a dynamically created path segment.

In various embodiments, the method further comprises the path adjust module replacing a remainder of the predetermined path with the one or more dynamically determined paths or path segments.

In various embodiments, the robotic vehicle is an autonomous mobile robot lift truck or tugger.

In accordance with another aspect of the inventive concepts, provided is a method of dynamically adjusting a path of an autonomous mobile robot, comprising a navigation system operatively controlling a drive system to navigate the mobile robot along a predetermined path, at least one sensor acquiring real-time sensor data, and a dynamic path adjust system processing the real-time sensor data to cause the navigation system to at least partially and/or temporarily deviate from the predetermined path based on the real-time sensor data.

In various embodiments, the method further comprises causing the navigation system to resume navigation on the predetermined path after deviating from the predetermined path.

In various embodiments, the predetermined path is a trained path stored in the at least one computer memory device.

In various embodiments, the sensor data includes real-time pose data.

In various embodiments, the autonomous mobile robot lift truck or tugger.

In accordance with another aspect of the inventive concepts, provided is a method of navigating a robotic vehicle including a navigation system, one or more sensors, and an executable dynamic path adjust module. The method comprises the navigation system operatively controlling a drive system to navigate the robotic vehicle along a current path, acquiring real-time sensor data from at least one of the one or more sensors, and the dynamic path adjust module determining whether a dynamic path adjustment should be executed, including processing the sensor data to determine if there is an obstruction in the current path, and/or determining if the current path is an original path that indicates a switch to dynamic path adjustment. If the dynamic path adjust module determines that a dynamic path adjustment should be executed, then the dynamic path adjust module dynamically determines a path or path segment and the method includes navigating the robotic vehicle using the dynamically determined path or path segment.

In various embodiments, the method includes the dynamic path adjust module causing the navigation system to resume navigation on the current path after navigating the at least one dynamically determined path or path segment.

In various embodiments, the current path is a trained path stored in at least one computer memory device of the robotic vehicle.

In various embodiments, the at least one sensor includes one or more three-dimensional sensors.

In various embodiments, the one or more stereo sensors includes one or more stereo cameras.

In various embodiments, the method further comprises determining real-time pose data from the sensor data.

In various embodiments, the method further comprises the dynamic path adjust module determining a vehicle pose from the real-time pose data when transitioning from the current path to the at least one dynamically determined path or path segment and returning the vehicle to the vehicle pose and transitioning back to the current path.

In various embodiments, the method further comprises the path adjust module swapping a path segment from the current path with a dynamically created path segment.

In various embodiments, the method further comprises the path adjust module replacing a remainder of the current path with the one or more dynamically determined paths or path segments.

In various embodiments, the robotic vehicle is an autonomous mobile robot lift truck or tugger.

In accordance with another aspect of the inventive concepts, provided is a robotic vehicle configured to execute the methods herein described.

In accordance with another aspect of the inventive concepts, provided is a method of dynamically adjusting a path of a navigating robotic vehicle as shown and described.

In accordance with another aspect of the inventive concepts, provided is a robotic vehicle configured to dynamically adjust its path as shown and described.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a perspective view of an AMR forklift that can be configured to implement dynamic path adjust, in accordance with aspects of the inventive concepts; and

FIG. 2 is a block diagram of an embodiment of an AMR, in accordance with aspects of the inventive concepts;

FIG. 3 is a flowchart depicting an embodiment of a method of dynamic path adjust, in accordance with aspects of the inventive concepts;

FIG. 4 shows embodiments of different robotic vehicle paths, in accordance with aspects of the inventive concepts; and

FIG. 5 provides a flowchart of an embodiment of a motion control method for a dynamically navigating robotic vehicle, in accordance with aspects of the inventive concepts.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

According to aspects of the inventive concepts, embodiments of a robotic vehicle described above can follow trained paths and augment, alter, and/or replace segments of those paths with dynamically determined paths (or path segments). A dynamically determined path or path segment is one determined from, at least in part, the sensor data as the robotic vehicle navigates. The addition of the dynamically determined navigation strategy enables the robotic vehicle to switch from its preplanned primary or trained path (one navigation strategy) to a dynamically determined path (another strategy), where it may switch back later to the primary navigation strategy or generate a new dynamically determined path strategy, as described above.

Typically, robotic vehicles are trained through manual demonstration of paths to follow and specifications of behaviors to perform at locations along those paths. But other methods include drawing a path on a map or specifying just start and end poses, allowing some automated system to plan the path. The inventive concepts could apply to these other methods just as well, provided that the original path (created by any method) is altered/augmented/replaced dynamically. Localization and navigation are performed by comparing visual features with those recorded during training. In accordance with aspects of the inventive concepts, robotic vehicles also support dynamic path planning based on real-time sensor data, or based at least in part real-time sensor data, such as the location of manipulation target objects and obstacles.

Dynamic navigation can be performed using a local map built from the sensor data collected during autonomous motion and/or navigation by the robotic vehicle. The inventive concepts provide a mechanism for switching from trained maps and navigation skills to dynamic navigation on local maps. This mechanism can be used at pre-trained locations to perform certain tasks (such as picks and drops) or as needed based on sensed conditions. As examples, the inventive concepts can be used for picks and drops on a variety of lift AMRs. In such applications, paths can be demonstrated as usual for mobile robot training until the approximate location of the action is reached. The trainer indicates that a dynamic action should be performed at this location, and then trains the remainder of the path as usual.

When this location is reached during automated following, the robotic vehicle senses the location of a pallet (for picks) or pallet drop location (for drops). It plans and executes a dynamic path to reach this location, performs the action, and returns to the trained path, optionally, with the same pose it had when it departed the trained path. The robotic vehicle then continues executing the remainder of the trained path. While traveling on the dynamic path, the “map” used to navigate trained paths may not be available, so the robotic vehicle can navigate using an alternate approach, as described in the related U.S. Provisional Patent Application 63/324,182 filed Mar. 28, 2022, entitled “Hybrid, Context-Aware Localization System for Ground Vehicles,” which is incorporated herein by reference.

In the context of a robotic vehicle, the inventive concepts can also be used for, among other things, obstacle avoidance. In this application, a dynamic path will be planned based on sensing an obstacle obstructing the trained path during autonomous follow. This dynamic path will depart from the trained path in order to avoid the obstacle, then rejoin the trained path at a different location farther along.

In various embodiments, the robotic vehicle functionality and/or path adjust module functionality can be implemented on a general-purpose Linux computer, using many open source packages. Some embodiments can benefit from use of the tf2 robot operating system (ROS) package, which is the known second generation of the transform library used for keeping track of multiple coordinate frames over time. In various embodiments, 3rd party sensors, such as the pallet detection system (PDS) by IFM Efector, Inc., can be used, but the inventive concepts are not limited to such sensors. Other sensors could be used in other embodiments.

In general, the prior approaches to manipulation of robotic vehicles have been open-loop, for example, relying on navigation using grid engine technology in order to reach locations where manipulation is planned, and then performing that manipulation without directly sensing the payload or any infrastructure. Any error in navigation is directly reflected in the location where the manipulation is performed, so navigational error can lead to the robotic vehicle attempting the manipulation at a different location to where it was trained. On the other hand, the target location, such as a pallet to be picked, may not be consistently placed in the trained location. For example, the robotic vehicle may need to pick pallets placed by humans with less precision than desired. In this case, since the robotic vehicle does not sense the pallet directly, it will try to pick it from the trained location.

In accordance with aspects of the inventive concepts, a new approach is able to compensate for errors in navigation, as well as changes in the manipulation or a lack of precision in the placement of a target object. Because the robotic vehicle closes the loop by sensing the location of its target, the robotic vehicle dynamically plans a path adjustment to accurately reach the target, mitigating both sources of error. This dynamic path planning necessarily relies on a different localization method tailored to the task.

Implementation of the inventive concepts allow robotic vehicles to have trained paths that pick or drop pallets reliably, despite variations in the pallet locations or small position error in the robotic vehicle's navigation. Currently, robotic vehicles must be trained “through” the action, with the training motion that will be precisely duplicated during path following. With the new inventive approach, the robotic vehicle can be trained to a location near the pallet or drop location. During autonomous trained path following, onboard sensing detects the precise location of this pick or drop target, e.g., pallet. A novel path is dynamically determined and executed to reach the sensed location, perform the action, and return to the trained path.

Therefore, the inventive concepts relate to the ability to deviate from a manually-trained path for robotic vehicles, such as autonomous mobile robots (AMRs). Obstacle avoidance has been one of the motivating use cases, but the lift truck reveals the need for another: visual servoing to a detected action location for a pick or drop.

Pivot turns of the lift chassis may also be considered a form of off-path navigation, since they may not be trained explicitly as part of the path. Alternately, training may be more complex, and the pivot plus subsequent approach may be trained as a complex behavior. The inventive concepts relate to, among other things, robotic vehicle, e.g., AMR, motion planning for lift actions as adjustments to a trained path.

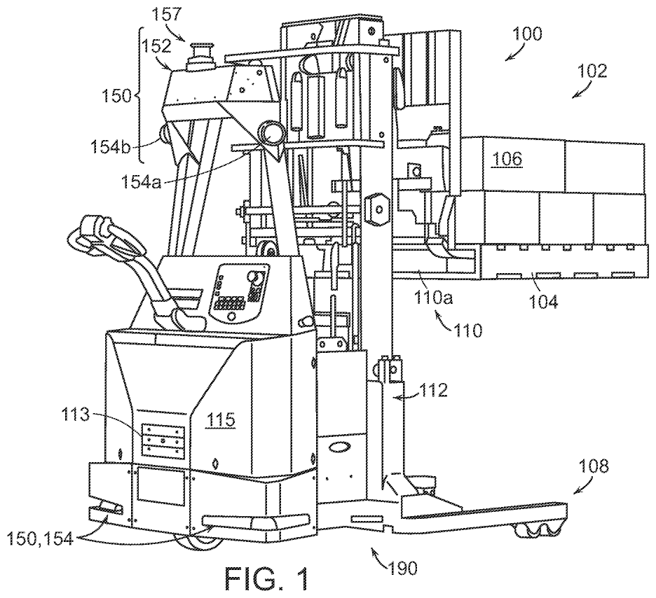

Referring to FIG. 1, shown is an example of a robotic vehicle 100 in the form of an AMR that can be configured with the sensing, processing, and memory devices and subsystems necessary and/or useful for performing dynamic path adjust in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods 106. To engage and carry the pallet 104, the robotic vehicle may include a pair of forks 110, including a first and second forks 10a,b. Outriggers 108 extend from a chassis 190 of the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path adaptation, including avoidance of detected objects, obstructions, hazards, humans, other robotic vehicles, and/or congestion during navigation.

In some embodiments, the sensors 150 can include one or more stereo cameras 152 and/or other volumetric sensors, sonar sensors, radars, and/or laser imaging, detection, and ranging (LiDAR) scanners or sensors 154, as examples. In the embodiment shown in FIG. 1, there are two LiDAR devices 154a, 154b positioned at the top left and right of the robotic vehicle 100. In the embodiment shown in FIG. 1, at least one of the LiDAR devices 154a,b can be a 2D or 3D LiDAR device. In alternative embodiments, a different number of 2D or 3D LiDAR device are positioned near the top of the robotic vehicle 100. Also, in this embodiment a LiDAR 157 is located at the top of the mast. In some embodiments LiDAR 157 is a 2D LiDAR used for localization.

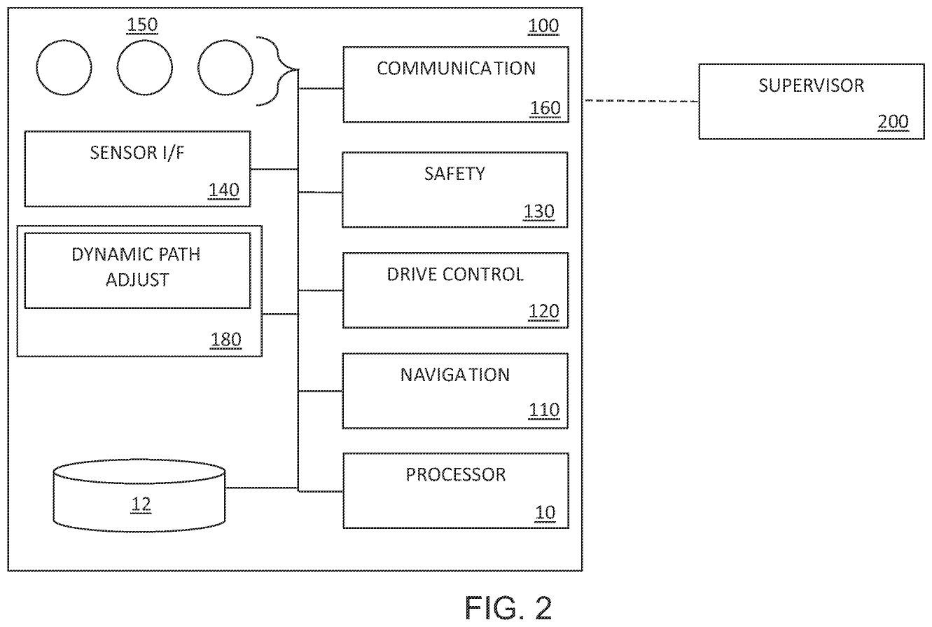

FIG. 2 is a block diagram of components of an embodiment of the robotic vehicle 100 of FIG. 1, incorporating path adaptation technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine the robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 110 configured to access environmental data, such as the electronic map, and path information stored in memory 12, as examples. The navigation module 110 can communicate instructions to a drive control subsystem 120 to cause the robotic vehicle 100 to navigate its path within the environment. During vehicle travel, the navigation module 110 may receive information from one or more sensors 150, via a sensor interface (I/F) 140, to control and adjust the navigation of the robotic vehicle. For example, the sensors 150 may provide sensor data to the navigation module 110 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

The sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154, 157, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

In example embodiments, the robotic vehicle 100 may use and/or include a dynamic path adjust module 180. In various embodiments, the dynamic path adjust module 180 comprises computer program code stored in memory 12 and executable by the at least one processor 10 to cause the navigation system 110 to at least partially or temporarily deviate from a predetermined path based on the real-time senor data from the sensors 150 and or other inputs, such as from supervisor 200, other robotic vehicles, and/or from other systems within the environment. That is, in various embodiments, dynamic path adjust refers to the robotic vehicle 100 adjusting its navigation in real-time based on information about the environment. Such information can include at least some sensor data acquired in real-time from sensors 150, which can be combined to sensor data previously acquired and/or other real-time information about the environment.

In various embodiments, the path, which is electronically defined as a path geometry, includes stops at a plurality of action locations. At each location is a place where the robotic vehicle 100 can perform one or more of its tasks, or action, such as pick up goods, drop off goods, charge its battery supply, or perform any other tasks indicated for the robotic vehicle. Performance of some of the tasks by the robotic vehicle may require a full stop at a location and others might require a slow down or pause at a location by the robotic vehicle. At some locations that robotic vehicle may interact with a human, but at others the robotic vehicle may be fully automated.

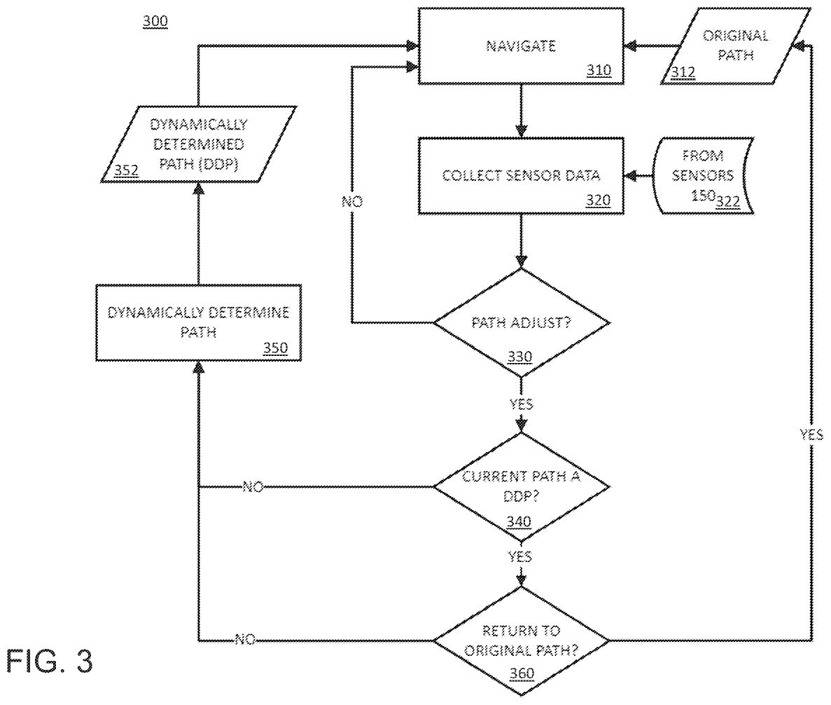

FIG. 3 is a flowchart depicting an embodiment of a method 300 of dynamic path adjust, in accordance with aspects of the inventive concepts. According to the method 300, the robotic vehicle 100 uses a current path and/or current path information 312 for navigation in step 310 as it navigated to perform a set of tasks at different locations within the environment. An original, preplanned path defining the tasks and/or locations can be a trained path or a path otherwise installed, downloaded, or communicated to the robotic vehicle 100. Thereafter, the current path being navigated by the robotic vehicle can be the original, preplanned path or a dynamically determined path (DDP) as described herein. That is, when the robotic vehicle initiates its path through an environment, which is a path defining a route through the electronic map that represents the environment to the robotic vehicle, the robotic vehicle can use an original, preplanned path that defines tasks and/or locations to be visited. The original, preplanned path can be a trained path, as described above. Each path can comprise path segments, where a path segment can define a portion of the path connecting locations to be visited by the robotic vehicle in performance of its tasks.

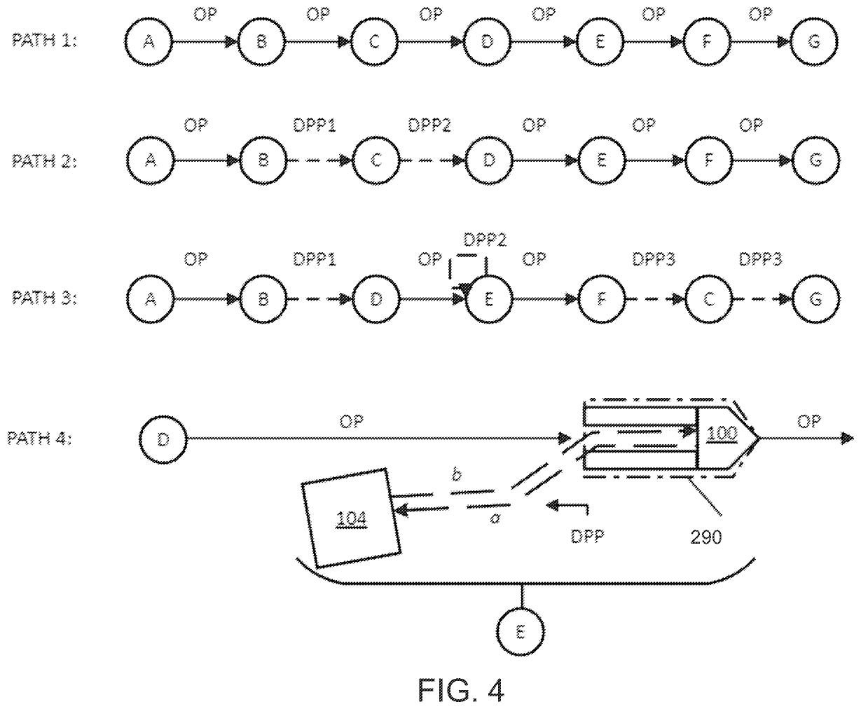

Referring to FIG. 4 as an example, if a robotic vehicle's 100 original planned path (OP) has stops A through G, one path segment defines the route from A to B, another from B to C, another from C to D, and so on. In FIG. 4 the originally planned path is Path 1, where “OP” is the originally planned path segment from one location to another location. In Path 1, all path segments are as originally planned.

Path 2 represents an embodiment where the robotic vehicle 100 has used different navigation strategies to navigate to locations A through G. In Path 2, the order of locations remains the same as originally planned path OP, as shown for Path 1. However, different navigation strategies have been used for the path segments from location B to C and from location C to D. From location D the robotic vehicle returned to its original navigation strategy, i.e., the originally planned path OP, for navigating from location D to E through G. The navigation strategy from location B to C is a first dynamically determined path (DDP1), which is different from originally planned path OP. And the path from location C to D is a second dynamically determined path (DDP2), which is different from DDP1 and OP.

Path 3 represents another embodiment where the robotic vehicle 100 has used different navigation strategies to navigate to locations A through G. In Path 3, the order of locations is different from the originally planned path OP, as shown for Path 1. Different navigation strategies have been used for the path segments from location B to D and from locations F to C and C to G. From locations D to E and E to F the robotic vehicle returned to its original navigation strategy, i.e., the originally planned path OP. The navigation strategy from location B to D is a first dynamically determined path (DDP1), which is different from originally planned path OP.

The path from location D to E can be the OP, but at location E the robotic vehicle can switch from the OP to a dynamically determined path DDP2 used to enable the vehicle to auto-adjust its orientation to facilitate and enable engagement of a target object at location E, e.g., pallet pick up or drop off. In Path 3, the DDP2 is shows as a dashed loop-back arrow from location E back to location E. The path from location F to C and from C to G is a second dynamically determined path (DDP3), which is different from DDP1, DDP2, and OP.

Path 4 represents an instance where the path from location D to location E is partially trained. Path 4 can be an example of the dynamic path adjust in Path 3, at location E. That is, from D to a location proximate to E the path can be a planned, original path OP, but proximate to E the robotic vehicle can switch to generate a dynamically determined path DPP that enables the robotic vehicle to adjust to the particular placement and/or orientation of a target object to be picked or engaged, for example pallet 104. Once picked or engaged, the robotic vehicle can then switch back to the original path OP and navigate to location E.

In path 4, the path geometry of the robotic vehicle 100 calls for it to stop and switch to dynamic path adjust. When it stops, the sensors 150 acquire sensor data used to determine a pose 290 of the vehicle at its stop. The dynamic path adjust module 180 collaborates with the navigation system 110, in conjunction with the other vehicle subsystems and modules such as the sensors 150 and the drive control subsystem 120, to generate the DDP to enable the robotic vehicle to “pick” the pallet 104, indicated by the dashed arrow a from the vehicle to the pallet. This first part of the DDP can be recorded by the vehicle. Once the pallet is picked, the dynamic path adjust module 180 can, in some embodiments, return the robotic vehicle to the pose 290 and then switch back to the original path OP. In some embodiments, the robotic vehicle can return the robotic vehicle to its pose 290 by reversing the stored first part of the DDP to generate a second part of the DDP, shown by the dashed arrow b from the pallet 104 back to the position of the pose. In other embodiments, other approaches to returning the vehicle to the original path OP can be used.

Returning to FIG. 3, in various embodiments, the inventive method 300 enables the robotic vehicle 100 to reroute its path or path segments by switching between different navigation strategies to avoid path or navigation disruption or interference or otherwise adjust its path to better perform its various tasks.

In step 310, the robotic vehicle 100 navigates using a current path, which can be the original path 312. During navigation, sensor data 322 is collected in step 320, e.g., from one or more of the sensors 150. Using the sensor data 322, the navigation module 110 determines whether path adjust should occur in step 330. The decision to adjust the path could be based on a detected path obstruction, congestion, or point in the current path defined for dynamic path adjustment. In step 330, if the determination is NO, the method continues to navigate using the current path in step 310, which can be original path 312 or a dynamically determined path 352.

However, if in step 330, the determination is YES, meaning the current path is to be adjusted, the method continues to step 340 to determine whether the current path is a dynamically determined path 352. If the answer is NO, the method proceeds to step 350 where the path adjust module 180 generates a DDP 352 and the robotic vehicle 100 switches its navigation strategy to use DDP 352 in step 310. If the answer in step 340 is YES, the method continues to step 360 where the path adjust module 180 determines whether to switch back to the original path 312 navigation strategy or generate a new DDP in step 350. If the robotic vehicle determines that the original path 312 can be resumed, then the path adjust module can switch the navigation strategy back to the original path 312 for navigation via step 310. But if the path adjust module determines in step 360 that the original path 312 cannot be resumed, then the path adjust module can cause the method to proceed to step 350 for generation of a new DDP 352 for navigation in step 310.

In various embodiments, the method 300 continues to cycle until the overall navigation is complete and the robotic vehicle has performed all tasks at all locations, as shown in FIG. 4. If need for path adjustment requires, the path adjust module 180 could, in some embodiments, add or delete a location and/or task from the original path and task list.

A dynamically determined path preferably enables the robotic vehicle to complete its originally planned tasks, wherein a task can be a stop to pick up and/or drop off goods, whether palletized or not. In some embodiments, the dynamically determined path is a detour from the original and/or current path, wherein the robotic vehicle makes all of its stops, either in the original order of the original path or in a different order from the original path. In some embodiments, the dynamically determined path is used at a target location to adjust vehicle orientation to engage with a target object. In various embodiments, the dynamic path adjust enables the robotic vehicle to navigate through the environment making all of the same stops as the original path, but with a different physical route through the environment, where the path is dynamically adjusted in real or near-real time to avoid or mitigate interference.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

In various embodiments, as described with respect to FIG. 1, the robotic vehicle can comprise:
a. Multiple sensors 150 as sources of pose estimation data, e.g., imaging devices such as stereo cameras that can produce pose data used for modeling the environment and navigating; a pose represents a position and orientation of an object, e.g., in three dimensions, where poses can be stored in real-time as sensor data in memory 12;
b. A navigation module 110 that includes a vision system for weighting/swapping between pose estimation sources, which can include computer executable code that applies weighting algorithms to features within poses and algorithms that compare poses for similarities and differences, including comparing weighted portions of two or more poses; weighting can be based on probabilities that the features are correctly determined based on the sensor data;
c. A dynamic path adjust module 180 configured to enable multiple strategies for path planning and navigation, such as pre-planned, trained navigation and/or dynamic navigation, wherein such strategies can be implemented using computer code that is executable to cause a vehicle drive control subsystem 120 to navigate the mobile robot through an environment, e.g., a warehouse;
d. The dynamic path adjust module 180, in cooperation with the navigation module 100, configured for swapping between navigation strategies, wherein such strategies can be implemented using computer code that is executable to maintain, alter, or augment navigation of the mobile robot, e.g., altering an initial (trained) navigation path with dynamically determined data and information, e.g., based on sensor data including pose data and/or comparative pose data. Altering the path, as a dynamically determined path, can be accomplished for any of a number of reasons or in response to any of a number of stimuli or conditions, e.g., congestion avoidance, collision avoidance, more efficient path, dynamic or enroute re-tasking of the mobile robot, etc.

In various embodiments, several potential use cases exist for the robotic vehicles in the form of lift trucks, for example, potentially including some general motion concepts, mostly with respect to end-effector manipulations. For purposes of motion planning, use cases can be roughly divided into three categories:

### 1. Single Pick/Drop

a. Floor-level pick/drop, including pull-through after action
b. Fixed-height table/apron pick/drop
c. Variable-height table pick/drop
d. Stacking and de-stacking of pallets
e. Transfer to/from AMR cart
f. Large positional variation (completely undefined, not for MVP)

### 2. Lane Staging

a Floor-level lane building and depletion

### 3. Variable/Multiple Height Pick/Drop

### a. Ground+1st level racking pick/drop

In some embodiments, common requirements in these use cases can include one or more of:
1. The navigation subsystem should not produce off-path errors while navigating beyond the trained path.
2. Any later planned Behaviors, including those at or just past the target action position location shall be delayed until a trained Cartesian position is reached for the location. Behaviors can include movements of the robotic vehicle and/or its load engagement portions used to pick up or drop of a pallet, in the case of a lift truck.
3. Any Behaviors required to complete the pick/drop action will be dynamically applied at the new action position location, as determined by the sensors 150.
4. Paths can be manually trained to approach each Trained Action Position, i.e., target location. That is, a trained path segment will reach the position of the action location or come close enough for sensors to detect and adequately localize at the pallet pick up or drop location.
5. For lanes and pull-through picks and drops, the actions can be trained as zones, delimiting the earliest and latest positions at which the action may occur. Training as zones can include training the robotic vehicle to navigate from zone to zone and, once in the zone, the robotic vehicle performing a load drop and a load engagement and removal within the zone without using predetermined load pick up and drop off locations. In various embodiments, the robotic vehicle can determine where to place a load within the zone based on proximity to another object or physical structure within the zone. In various embodiments, training as zones can be accomplished as described in U.S. Provisional Appl. 63/423,679, filed Nov. 8, 2022, entitled System and Method for Definition of a Zone of Dynamic Behavior with a Continuum of Possible Actions and Structural Locations within Same, which is incorporated herein by reference. In all other cases, the action can be trained at a cusp in the path (transition between direction of travel).
6. Dynamic travel will terminate in the same position at which it began: the Trained Action Position. Any motion executed in order to perform the action can be reversed, so that normal path following of the original path can resume from the pose at which it ended and the dynamically determined path began.
7. Obstacle detection can rely on path projections. A static-world assumption can be applied during the short final approach to the action target, using previously saved (rather than live streaming) point clouds, i.e., probability-based evidence grid representations of real-world entities.

To dynamically plan motion off the originally trained and built path, two broad categories of approaches can be used to generate dynamically determined paths or path segments: either a new path (or path segments) may be created, or a separate, more-reactive mode of motion control could be used, similar to visual servoing.

### Dynamic Path Options

Paths can be defined as path geometries and a path geometry can be represented in memory by many different types of data structures. Dynamic path creation could be accomplished either by planning an entirely new path, or by inserting additional path segments into a current path. As one example, a path segment can be represented as a series of combined segments in the form of splines. Implementation details may make one approach more convenient, but either could involve the creation of the same path segments used to represent path geometry during normal following. If off-path travel is defined to only occur at the end of a spur, normal following can be resumed when the off-path travel completes, and inserting new segments in the current path will still result in a path that is continuous, to at least a 1^{st} order. That is, endpoints at the transition from one path to another are continuous (0^{th} order) and have the same heading (1^{st} order). This level of continuity can also be enforced by the path formulation approach used. Second order continuity is also likely, if the off-path motion is limited to straight motion, and the spur (or any path segment approaching a Trained Action Position (or target location)) is likely to consist of straight motion (or a pivots). Alternately, off-path travel may include the spur itself, in which case the change of direction moots any concerns about path continuity.

This approach can be most convenient for the obstacle detection used during path assist. Path assist routines can rely on vehicle poses predicted by the vehicle's motion control functionality while following a planned path geometry. That is, the normal motion planning algorithm can be run against the normal path representation, and the evolving vehicle pose is advanced within the point cloud used for obstacle detection.

### Dynamic Path Augmentation

One option for following a dynamically adjusted path plan would be for the path adjust module 180 to insert additional path segments in the current path. This could occur at a cusp (in the case of a conventionally trained path) or at any point in a segment of motion (in the case of dynamically planned path or path segment). In some embodiments, the robotic vehicle might preferably come to a stop while creating the new path segments, which would begin and end at the robotic vehicle's current pose at the stop. The positions of any later robotic vehicle behaviors on the path could be adjusted to account for any additional travel distance added. Any software components relying on a copy of the path data structure could be notified of the update or altered to reference a single dynamic path.

### Dynamic Path Swapping

Instead of inserting additional segments in the current path, in some embodiments the path adjust module 180 could replace the path with a new one temporarily. This would be conceptually similar to a 2-element stack, where any state associated with the original path would be saved when the new path is started and restored when it ends. As before, this could be implemented such that the new path ends at the same pose as it began.

Visual Servoing: Visual servoing typically describes a system in which a tight feedback loop between sensors and actuators (often a manipulator, but this can apply to an entire mobile platform) is used to attain a desired pose of the actuated body relative to some target detectable by visual sensors. An additional target may be affixed to the actuated body for relative pose determination, or proprioception (pose estimation, for the case of a mobile platform) may be used. The distinction between this solution and the previous case is that a full path geometry is not computed prior to beginning movement. Instead, the motion of individual axes would be determined and executed serially.

A path geometry can be built incrementally with each planned motion. This can be done in the original point cloud, or a new/augmented point cloud that can be built with additional sensor information, if available. In fact, this approach may even accommodate changing vehicle geometry more easily. For example, if a robotic vehicle is carrying an oversized load near potential obstructions, such as racking, the bounding box of the robotic vehicle that must be checked for collisions may change significantly between motions of the carriage. In some embodiments, piecewise obstruction detection could be used to handle changing vehicle shape between segments of the path.

Motion Control: The dynamic path options using conventional path geometry could be the most straightforward approach for motion control. The same algorithm used for following any other path could be used for following the dynamic path. Visual Servoing could be used for the fork carriage axes of a lift truck and could also be useful for traction/steering as well, especially if sensing and/or actuation are inaccurate enough that iteration is required to reach the intended position.

On-the-fly Replanning: Visual Servoing and Dynamic Path Swapping could, in some embodiments, both require the robotic vehicle to come to a stop to transition between pre-planned and dynamic paths, while Dynamic Path Augmentation could permit on-the-fly modifications to the path geometry while moving. On-the-fly path modification would be ideal for an obstacle avoidance implementation; this feature could also be implemented with a “stop and sense” step. Even with Path Swapping, the dynamic path could be continuously updated in an obstacle avoidance scenario.

Obstacle Detection: Planning an entire path at a time fits well with some lift use cases that rely on the Static World Assumption. Even in an incremental approach to sensing, planning a complete path geometry is not an onerous requirement-for example, in a theoretical obstruction avoidance scenario, in which the extent of the path obstruction is only incrementally revealed as the robotic vehicle continues to move around the obstruction. It is still reasonable in this case to plan the entirety of off-path travel in a path geometry that eventually rejoins with the primary path at some point in the future. As more of the obstruction is revealed, the dynamic path could be augmented or replaced.

Discrete Behavior Switching: The Dynamic Path Swapping and Visual Servoing approaches introduce a distinct boundary between the primary (originally trained) and dynamic paths. This could provide an enforceable separation between the sets of behaviors executed on each path. It can be advantageous to have a mechanism ensuring that primary path behaviors are not run while executing dynamic motion, even when the robotic vehicle's position happens to be close. For the lift truck use cases, this segregation of behaviors is reasonable because the dynamic portion of the path is always an addition to the primary path-an optional spur. For obstacle avoidance, though, the dynamic path may be replacing a portion of the primary path. In this case, replacement of some behaviors might not be allowed, but other behaviors might be candidates for execution during a diversion from the originally planned primary path.

Dynamic Rerouting: Another feature that could be implemented by the path adjust module 180 in some embodiments is the ability to replan a route through the existing path network, while a route is already executing. This feature involves changing some portion of the path geometry while the robotic vehicle is following a current path. Alternatively, in some embodiments, this could be formulated as Path Swapping without returning to the original path.

### Implementation

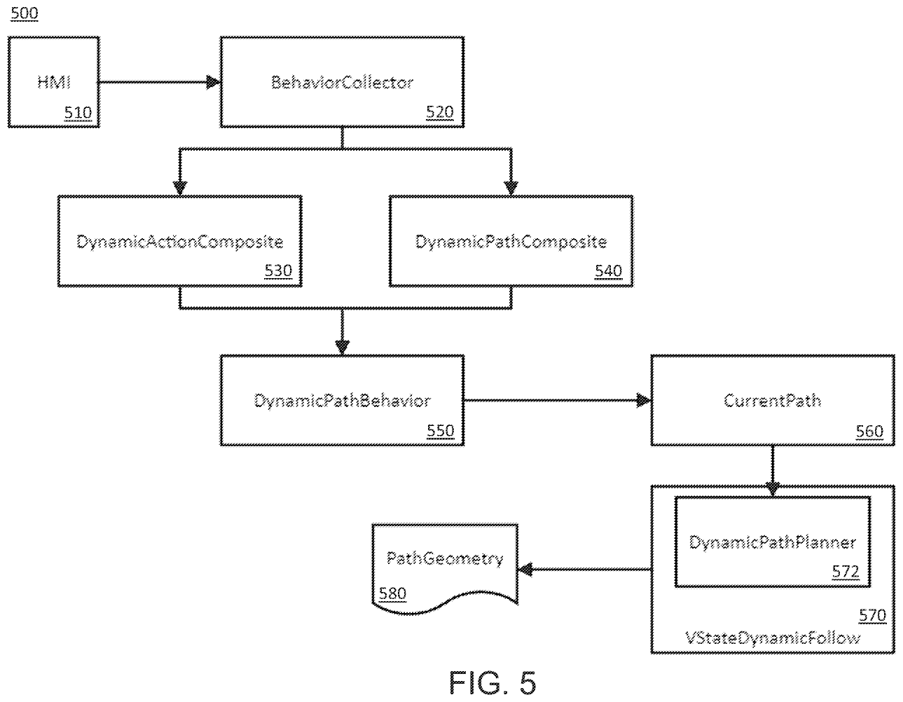

FIG. 5 provides a flowchart of an embodiment of a motion control method 500 implemented by the path adjust module 180 for dynamically navigating robotic vehicle 100.

The method starts at step 510 wherein a human user interacts with a human machine interface (HMI), which can include a graphical user interface (GUI), to define behaviors, via a BehaviorCollector 520, associated with defining the actions of the robotic vehicle 100 while navigating its path. As with Path 4 of FIG. 3, in this embodiment a user defines portions of the path that are trained and portions of the path that are dynamically determined, e.g., close to a pallet to be picked. The dynamic portion close to the action location where the pallet (target) is placed allows the robotic vehicle the freedom to adjust to specific placement and/or orientation of the target object at the target location.

According to the method 500, two Composites are created for dynamic paths. The first will unconditionally create and follow a dynamic path, and the second will combine the functionality of an action and will only run when requested by the planner.

First, a DynamicPathComposite 540 will be created to control the generation of a path and the transitions between the primary (e.g., original) path and the dynamically determined path. The DynamicPathComposite will generate a new DynamicPathBehavior 550. This Behavior will trigger a transition to VStateDynamicFollow 570, which will manage the creation and execution of the new PathGeometry 580.

The second new composite will be called DynamicActionComposite 530. This Composite will inherit from both DynamicPathComposite and an ActionComposite, so that the dynamic path (including any stops) will only be executed if the associated Action is requested by the planner. The information about the particular action to perform will be used to help generate the PathGeometry 580 by the DynamicPathPlanner 572.

A VStateDynamicFollow singleton 570 is created for planning and following the dynamic path of the PathGeometry 580.

Methods 300 and 500, when executed, enable the robotic vehicle 100 to select and use one of a plurality of navigation strategies, and to switch between navigation strategies during the performance of a task and navigation of a path. The inventive concepts can be implemented with any of a plurality of robotic vehicles, including AMRs, that have sensors to detect various types of objects within the environment and on the route being traveled. The methods may selectively implement and/or change navigation strategies based on such detected objects and/or at predetermined points along a primary or originally planned path. For example, the robotic vehicle could implement a dynamically determined path at payload pickup and/or payload deposit locations and then resume in the primary or original path.

In accordance with aspects of the inventive concepts, implementing the methods, the robot vehicle 100 can navigate based on contextually appropriate navigation strategies, i.e., use a navigation strategy best suited for the context or current circumstances of the robotic vehicle. Collectively, the robotic vehicle 100 executing the method forms a system, which is a robotic vehicle configured to perform dynamic path adjust based, at least in part, on sensor data. As an example, the robotic vehicle can be configured to navigate on a combination of trained primary paths and dynamically determined paths.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. A robotic vehicle, comprising:
at least one processor in communication with at least one computer memory device;
a navigation system in operative control of a drive system to navigate the robotic vehicle along a predetermined path;
at least one sensor configured to acquire real-time sensor data; and
a dynamic path adjust module comprising computer program code executable by the at least one processor to cause the navigation system to generate at least one dynamically determined path or path segment based on the real-time senor data, wherein the at least one dynamically determined path or path segment at least partially and/or temporarily deviates from the predetermined path.

2. The robotic vehicle of claim 1, wherein the dynamic path adjust module is configured to cause the navigation system to resume navigation on the predetermined path after navigating the at least one dynamically determined path or path segment.

3. The robotic vehicle of claim 1, wherein the predetermined path is a trained path stored in the at least one computer memory device.

4. The robotic vehicle of claim 1, wherein the at least one sensor includes one or more three-dimensional sensors.

5. The robotic vehicle of claim 4, wherein the one or more stereo sensors includes one or more stereo cameras.

6. The robotic vehicle of claim 4, wherein the sensor data includes real-time pose data.

7. The robotic vehicle of claim 6, wherein the dynamic path adjust module is configured to determine a vehicle pose from the real-time pose data when transitioning from the predetermined path to the at least one dynamically determined path or path segment and to return the vehicle to the vehicle pose and transition back to the predetermined path.

8. The robotic vehicle of claim 1, wherein the path adjust module is configured to swap a path segment from the predetermined path with a dynamically created path segment.

9. The robotic vehicle of claim 1, wherein the path adjust module is configured to replace a remainder of the predetermined path with the one or more dynamically determined path or path segments.

10. The robotic vehicle of claim 1, wherein the robotic vehicle is an autonomous mobile robot lift truck or tugger.

11. A path adjust method for a robotic vehicle, the robotic vehicle comprising:
a navigation system operatively controlling a drive system to navigate the robotic vehicle along a predetermined path;
at least one sensor; and
a dynamic path adjust module comprising computer program code executable by the at least one processor to cause the robotic vehicle to perform a method that includes:
navigating the robotic vehicle on a predetermined path;
collecting sensor data in real-time; and
executing the dynamic path adjust module program code, including generating at least one dynamically determined path or path segment based on the real-time senor data, wherein the at least one dynamically determined path or path segment at least partially and/or temporarily deviates from the predetermined path.

12. The method of claim 11, including the dynamic path adjust module causing the navigation system to resume navigation on the predetermined path after navigating the at least one dynamically determined path or path segment.

13. The method of claim 11, wherein the predetermined path is a trained path stored in the at least one computer memory device.

14. The method of claim 11, wherein the at least one sensor includes one or more three-dimensional sensors.

15. The method of claim 14, wherein the one or more stereo sensors includes one or more stereo cameras.

16. The method of claim 14, further comprising determining real-time pose data from the sensor data.

17. The method of claim 16, further comprising the dynamic path adjust module determining a vehicle pose from the real-time pose data when transitioning from the predetermined path to the at least one dynamically determined path or path segment and returning the vehicle to the vehicle pose and transitioning back to the predetermined path.

18. The method of claim 11, further comprising the path adjust module swapping a path segment from the predetermined path with a dynamically created path segment.

19. The method of claim 11, further comprising the path adjust module replacing a remainder of the predetermined path with the one or more dynamically determined paths or path segments.

20. The method of claim 11, wherein the robotic vehicle is an autonomous mobile robot lift truck or tugger.

21. A method of dynamically adjusting a path of an autonomous mobile robot, comprising:
a navigation system operatively controlling a drive system to navigate the mobile robot along a predetermined path;
at least one sensor acquiring real-time sensor data; and
a dynamic path adjust system processing the real-time sensor data to cause the navigation system to at least partially and/or temporarily deviate from the predetermined path based on the real-time sensor data.

22.-38. (canceled)
